(19) United States
(12) Patent Application Publication
(10) Pub. No.: US 2025/0356504 A1
(43) Pub. Date: Nov. 20, 2025

(54) BLOCK SEARCHING PROCEDURE FOR MOTION ESTIMATION

(71) Applicant: QUALCOMM Incorporated, San Diego, CA (US)

(72) Inventors: Yongjun XU, Beijing (CN); Nan ZHANG, Beijing (CN); Bo DU, Xi'an (CN); Xiaokai WEN, San Diego, CA (US); Robert VANREENEN, San Diego, CA (US)

(21) Appl. No.: 18/874,577

(22) PCT Filed: Jul. 27, 2022
(86) PCT No.: PCT/CN2022/108124

§ 371 Date: Dec. 12, 2024

(51) Int. Cl. G06T 7/238; G06T 7/207; H04N 7/01

(52) U.S. Cl. CPC G06T 7/238; G06T 7/207; H04N 7/0127; G06T 2207/20016

(57) ABSTRACT

Aspects presented herein relate to methods and devices for display processing including an apparatus, e.g., a GPU or a CPU. The apparatus may obtain a first frame and a second frame of a plurality of frames in a scene. The apparatus may also calculate a set of first motion vectors in the first frame and a set of second motion vectors in the second frame, where the set of first motion vectors and the set of second motion vectors are calculated based on a block matching procedure. Further, the apparatus may estimate at least one third frame in the plurality of frames based on the set of first motion vectors in the first frame and the set of second motion vectors in the second frame, where the at least one third frame is subsequent to the second frame in the plurality of frames.

### TECHNICAL FIELD

The present disclosure relates generally to processing systems and, more particularly, to one or more techniques for graphics processing.

### INTRODUCTION

Computing devices often perform graphics and/or display processing (e.g., utilizing a graphics processing unit (GPU), a central processing unit (CPU), a display processor, etc.) to render and display visual content. Such computing devices may include, for example, computer workstations, mobile phones such as smartphones, embedded systems, personal computers, tablet computers, and video game consoles. GPUs are configured to execute a graphics processing pipeline that includes one or more processing stages, which operate together to execute graphics processing commands and output a frame. A central processing unit (CPU) may control the operation of the GPU by issuing one or more graphics processing commands to the GPU. Modern day CPUs are typically capable of executing multiple applications concurrently, each of which may need to utilize the GPU during execution. A display processor is configured to convert digital information received from a CPU to analog values and may issue commands to a display panel for displaying the visual content. A device that provides content for visual presentation on a display may utilize a GPU and/or a display processor.

A GPU of a device may be configured to perform the processes in a graphics processing pipeline. Further, a display processor or display processing unit (DPU) may be configured to perform the processes of display processing. However, with the advent of wireless communication and smaller, handheld devices, there has developed an increased need for improved graphics or display processing.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a graphics processing unit (GPU), a central processing unit (CPU), a display processing unit (DPU), a digital signal processor (DSP), or any apparatus that may perform graphics processing. The apparatus may obtain a first frame and a second frame of a plurality of frames in a scene, where the second frame is subsequent to the first frame in the plurality of frames. The apparatus may also perform a block matching procedure for a set of first blocks in the first frame and a set of second blocks in the second frame, where a set of first motion vectors and a set of second motion vectors are calculated based on the block matching procedure. Additionally, the apparatus may calculate a set of first motion vectors in the first frame and a set of second motion vectors in the second frame, where the set of first motion vectors and the set of second motion vectors are calculated based on a block matching procedure for a set of first blocks in the first frame and a set of second blocks in the second frame, where each of the set of first blocks includes a plurality of first pixels and each of the set of second blocks includes a plurality of second pixels, where the block matching procedure is associated with comparing at least one first block of the set of first blocks to at least one second block of the set of second blocks. The apparatus may also estimate at least one third frame in the plurality of frames based on the set of first motion vectors in the first frame and the set of second motion vectors in the second frame, where the at least one third frame is subsequent to the second frame in the plurality of frames. Moreover, the apparatus may transmit the at least one third frame after estimating the at least one third frame, where the at least one third frame is transmitted to a display or a display panel.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a block diagram that illustrates an example content generation system.

FIG. 2 illustrates an example graphics processing unit (GPU).

FIG. 3 illustrates an example display framework including a display processor and a display.

FIG. 4 is a diagram illustrating an example mask layer for display or graphics processing.

FIG. 5 is a diagram illustrating an example block matching procedure for graphics processing.

FIG. 6 is a diagram illustrating an example block matching procedure for graphics processing.

FIG. 7 is a diagram illustrating an example block matching procedure for graphics processing.

FIG. 8 is a communication flow diagram illustrating example communications between a GPU, a graphics processing component, and a display.

FIG. 9 is a flowchart of an example method of graphics processing.

FIG. 10 is a flowchart of an example method of graphics processing.

### DETAILED DESCRIPTION

Frame extrapolations may be based on motion vector estimation and/or motion compensation. In a motion estimation stage, frame extrapolation may use two existing input frames to calculate a motion vector from one frame to the other frame for each block. Then, in a motion compensation stage, a new frame may be extrapolated from the base frame and its motion vectors. For example, in a motion estimation stage, frame extrapolation may utilize input frame N−1 and input frame N to calculate a motion vector from frame N−1 to frame N for each block. In the motion compensation stage, a new frame N+1 may be extrapolated from the base frame N and its motion vectors. Block matching is a procedure that may be used to estimate/calculate motion vectors to determine a best matched block. For instance, block matching may be applied on each block of a target frame in order to determine a best matched block in a reference frame. Block matching may perform a full range search to find the best matched block in a reference frame in order to reduce the cost of the motion estimation. The estimated/calculated motion vectors may be the translation from a current block to a best matched block. In some aspects, block matching may fail to estimate correct motion vectors and/or fail to correctly report object deformation. For instance, some block matching algorithms may have accuracy limitations. Also, block matching-based algorithms may rely on raw pixel value matching, but may have no understanding of real game/application content (e.g., objects, scene, characters, etc.). Accordingly, block matching may cause unexpected artifacts in the generated frames in certain situations. For example, block matching motion vector errors/limitations may be accepted by video encoding-decoding systems and computer vision (CV) systems (e.g., artificial intelligence (AI)). Additionally, real time game frame extrapolation may have different motion estimations specifications compared to video encoder-decoder and AI-CV scenarios. Also, smartphone vendors and game vendors may desire corresponding solutions to these issues. Block matching motion vector errors/limitations may also equate to a bad experience for real-time game/application frame extrapolations. Further, motion vector errors may lead to a deformation in game objects, which may result in noticeable game flickers and deformation. Aspects of the present disclosure may utilize block matching procedures that address the aforementioned issues. For instance, aspects of the present disclosure may utilize depth information in block matching procedures in order to distinguish objects in a scene. For example, the depth information in block matching procedures may help to distinguish different objects within backgrounds and foregrounds of frames in a scene. Further, aspects presented herein may add a new test block (e.g., a Z-test block) to blocking matching algorithms. By doing so, aspects presented herein may help to solve the issue of object deformation in graphics processing. Also, aspects of the present disclosure may use a depth map buffer to guide block searching in block matching. For instance, aspects presented herein may help to provide accurate depth information (e.g., Z information). This depth information may not be available in video encoder-decoder and computer vision block matching scenarios. Further, aspects presented herein may provide an accurate pixel/fragment depth buffer and Z-test, such as for a GPU rendering pipeline. For frame extrapolation of sequential frames, the paired matched blocks may indicate fragments/pixels of a same object. These pixels/fragments Z-axis and depth values may be the same or similar. Further, the Z-axis of the paired matched blocks may be the same or similar.

Various aspects of systems, apparatuses, computer program products, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of this disclosure to those skilled in the art. Based on the teachings herein one skilled in the art should appreciate that the scope of this disclosure is intended to cover any aspect of the systems, apparatuses, computer program products, and methods disclosed herein, whether implemented independently of, or combined with, other aspects of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. Any aspect disclosed herein may be embodied by one or more elements of a claim.

Although various aspects are described herein, many variations and permutations of these aspects fall within the scope of this disclosure. Although some potential benefits and advantages of aspects of this disclosure are mentioned, the scope of this disclosure is not intended to be limited to particular benefits, uses, or objectives. Rather, aspects of this disclosure are intended to be broadly applicable to different wireless technologies, system configurations, networks, and transmission protocols, some of which are illustrated by way of example in the figures and in the following description. The detailed description and drawings are merely illustrative of this disclosure rather than limiting, the scope of this disclosure being defined by the appended claims and equivalents thereof.

Several aspects are presented with reference to various apparatus and methods. These apparatus and methods are described in the following detailed description and illustrated in the accompanying drawings by various blocks, components, circuits, processes, algorithms, and the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors (which may also be referred to as processing units). Examples of processors include microprocessors, microcontrollers, graphics processing units (GPUs), general purpose GPUs (GPGPUs), central processing units (CPUs), application processors, digital signal processors (DSPs), reduced instruction set computing (RISC) processors, systems-on-chip (SOC), baseband processors, application specific integrated circuits (ASICs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software may be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise. The term application may refer to software. As described herein, one or more techniques may refer to an application, i.e., software, being configured to perform one or more functions. In such examples, the application may be stored on a memory, e.g., on-chip memory of a processor, system memory, or any other memory. Hardware described herein, such as a processor may be configured to execute the application. For example, the application may be described as including code that, when executed by the hardware, causes the hardware to perform one or more techniques described herein. As an example, the hardware may access the code from a memory and execute the code accessed from the memory to perform one or more techniques described herein. In some examples, components are identified in this disclosure. In such examples, the components may be hardware, software, or a combination thereof. The components may be separate components or sub-components of a single component.

Accordingly, in one or more examples described herein, the functions described may be implemented in hardware, software, or any combination thereof. If implemented in software, the functions may be stored on or encoded as one or more instructions or code on a computer-readable medium. Computer-readable media includes computer storage media. Storage media may be any available media that may be accessed by a computer. By way of example, and not limitation, such computer-readable media may comprise a random access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that may be used to store computer executable code in the form of instructions or data structures that may be accessed by a computer.

In general, this disclosure describes techniques for having a graphics processing pipeline in a single device or multiple devices, improving the rendering of graphical content, and/or reducing the load of a processing unit, i.e., any processing unit configured to perform one or more techniques described herein, such as a GPU. For example, this disclosure describes techniques for graphics processing in any device that utilizes graphics processing. Other example benefits are described throughout this disclosure.

As used herein, instances of the term “content” may refer to “graphical content,” “image,” and vice versa. This is true regardless of whether the terms are being used as an adjective, noun, or other parts of speech. In some examples, as used herein, the term “graphical content” may refer to a content produced by one or more processes of a graphics processing pipeline. In some examples, as used herein, the term “graphical content” may refer to a content produced by a processing unit configured to perform graphics processing. In some examples, as used herein, the term “graphical content” may refer to a content produced by a graphics processing unit.

In some examples, as used herein, the term “display content” may refer to content generated by a processing unit configured to perform displaying processing. In some examples, as used herein, the term “display content” may refer to content generated by a display processing unit. Graphical content may be processed to become display content. For example, a graphics processing unit may output graphical content, such as a frame, to a buffer (which may be referred to as a framebuffer). A display processing unit may read the graphical content, such as one or more frames from the buffer, and perform one or more display processing techniques thereon to generate display content. For example, a display processing unit may be configured to perform composition on one or more rendered layers to generate a frame. As another example, a display processing unit may be configured to compose, blend, or otherwise combine two or more layers together into a single frame. A display processing unit may be configured to perform scaling, e.g., upscaling or downscaling, on a frame. In some examples, a frame may refer to a layer. In other examples, a frame may refer to two or more layers that have already been blended together to form the frame, i.e., the frame includes two or more layers, and the frame that includes two or more layers may subsequently be blended.

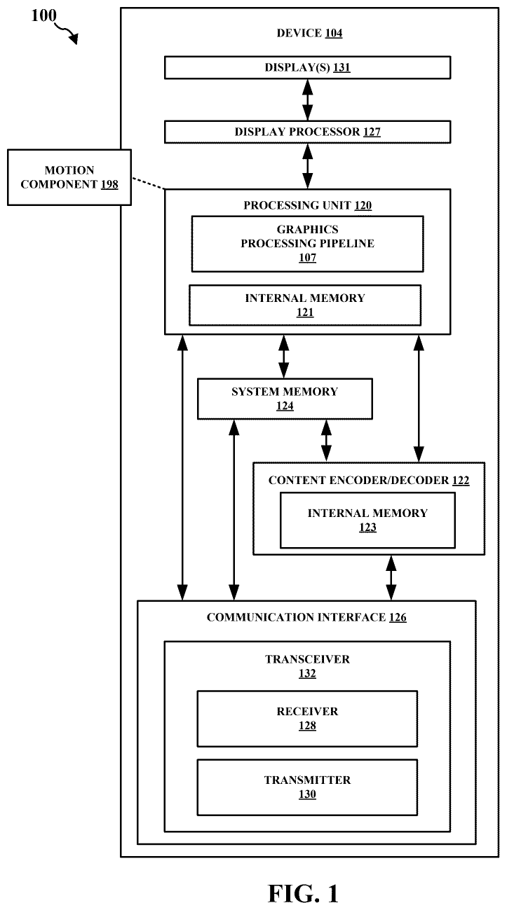

FIG. 1 is a block diagram that illustrates an example content generation system 100 configured to implement one or more techniques of this disclosure. The content generation system 100 includes a device 104. The device 104 may include one or more components or circuits for performing various functions described herein. In some examples, one or more components of the device 104 may be components of an SOC. The device 104 may include one or more components configured to perform one or more techniques of this disclosure. In the example shown, the device 104 may include a processing unit 120, a content encoder/decoder 122, and a system memory 124. In some aspects, the device 104 may include a number of components, e.g., a communication interface 126, a transceiver 132, a receiver 128, a transmitter 130, a display processor 127, and one or more displays 131. Reference to the display 131 may refer to the one or more displays 131. For example, the display 131 may include a single display or multiple displays. The display 131 may include a first display and a second display. The first display may be a left-eye display and the second display may be a right-eye display. In some examples, the first and second display may receive different frames for presentment thereon. In other examples, the first and second display may receive the same frames for presentment thereon. In further examples, the results of the graphics processing may not be displayed on the device, e.g., the first and second display may not receive any frames for presentment thereon. Instead, the frames or graphics processing results may be transferred to another device. In some aspects, this may be referred to as split-rendering.

The processing unit 120 may include an internal memory 121. The processing unit 120 may be configured to perform graphics processing, such as in a graphics processing pipeline 107. The content encoder/decoder 122 may include an internal memory 123. In some examples, the device 104 may include a display processor, such as the display processor 127, to perform one or more display processing techniques on one or more frames generated by the processing unit 120 before presentment by the one or more displays 131. The display processor 127 may be configured to perform display processing. For example, the display processor 127 may be configured to perform one or more display processing techniques on one or more frames generated by the processing unit 120. The one or more displays 131 may be configured to display or otherwise present frames processed by the display processor 127. In some examples, the one or more displays 131 may include one or more of: a liquid crystal display (LCD), a plasma display, an organic light emitting diode (OLED) display, a projection display device, an augmented reality display device, a virtual reality display device, a head-mounted display, or any other type of display device.

Memory external to the processing unit 120 and the content encoder/decoder 122, such as system memory 124, may be accessible to the processing unit 120 and the content encoder/decoder 122. For example, the processing unit 120 and the content encoder/decoder 122 may be configured to read from and/or write to external memory, such as the system memory 124. The processing unit 120 and the content encoder/decoder 122 may be communicatively coupled to the system memory 124 over a bus. In some examples, the processing unit 120 and the content encoder/decoder 122 may be communicatively coupled to each other over the bus or a different connection.

The content encoder/decoder 122 may be configured to receive graphical content from any source, such as the system memory 124 and/or the communication interface 126. The system memory 124 may be configured to store received encoded or decoded graphical content. The content encoder/decoder 122 may be configured to receive encoded or decoded graphical content, e.g., from the system memory 124 and/or the communication interface 126, in the form of encoded pixel data. The content encoder/decoder 122 may be configured to encode or decode any graphical content.

The internal memory 121 or the system memory 124 may include one or more volatile or non-volatile memories or storage devices. In some examples, internal memory 121 or the system memory 124 may include RAM, SRAM, DRAM, erasable programmable ROM (EPROM), electrically erasable programmable ROM (EEPROM), flash memory, a magnetic data media or an optical storage media, or any other type of memory.

The internal memory 121 or the system memory 124 may be a non-transitory storage medium according to some examples. The term “non-transitory” may indicate that the storage medium is not embodied in a carrier wave or a propagated signal. However, the term “non-transitory” should not be interpreted to mean that internal memory 121 or the system memory 124 is non-movable or that its contents are static. As one example, the system memory 124 may be removed from the device 104 and moved to another device. As another example, the system memory 124 may not be removable from the device 104.

The processing unit 120 may be a central processing unit (CPU), a graphics processing unit (GPU), a general purpose GPU (GPGPU), or any other processing unit that may be configured to perform graphics processing. In some examples, the processing unit 120 may be integrated into a motherboard of the device 104. In some examples, the processing unit 120 may be present on a graphics card that is installed in a port in a motherboard of the device 104, or may be otherwise incorporated within a peripheral device configured to interoperate with the device 104. The processing unit 120 may include one or more processors, such as one or more microprocessors, GPUs, application specific integrated circuits (ASICs), field programmable gate arrays (FPGAs), arithmetic logic units (ALUs), digital signal processors (DSPs), discrete logic, software, hardware, firmware, other equivalent integrated or discrete logic circuitry, or any combinations thereof. If the techniques are implemented partially in software, the processing unit 120 may store instructions for the software in a suitable, non-transitory computer-readable storage medium, e.g., internal memory 121, and may execute the instructions in hardware using one or more processors to perform the techniques of this disclosure. Any of the foregoing, including hardware, software, a combination of hardware and software, etc., may be considered to be one or more processors.

The content encoder/decoder 122 may be any processing unit configured to perform content decoding. In some examples, the content encoder/decoder 122 may be integrated into a motherboard of the device 104. The content encoder/decoder 122 may include one or more processors, such as one or more microprocessors, application specific integrated circuits (ASICs), field programmable gate arrays (FPGAs), arithmetic logic units (ALUs), digital signal processors (DSPs), video processors, discrete logic, software, hardware, firmware, other equivalent integrated or discrete logic circuitry, or any combinations thereof. If the techniques are implemented partially in software, the content encoder/decoder 122 may store instructions for the software in a suitable, non-transitory computer-readable storage medium, e.g., internal memory 123, and may execute the instructions in hardware using one or more processors to perform the techniques of this disclosure. Any of the foregoing, including hardware, software, a combination of hardware and software, etc., may be considered to be one or more processors.

In some aspects, the content generation system 100 may include a communication interface 126. The communication interface 126 may include a receiver 128 and a transmitter 130. The receiver 128 may be configured to perform any receiving function described herein with respect to the device 104. Additionally, the receiver 128 may be configured to receive information, e.g., eye or head position information, rendering commands, or location information, from another device. The transmitter 130 may be configured to perform any transmitting function described herein with respect to the device 104. For example, the transmitter 130 may be configured to transmit information to another device, which may include a request for content. The receiver 128 and the transmitter 130 may be combined into a transceiver 132. In such examples, the transceiver 132 may be configured to perform any receiving function and/or transmitting function described herein with respect to the device 104.

Referring again to FIG. 1, in certain aspects, the processing unit 120 may include a motion component 198 configured to obtain a first frame and a second frame of a plurality of frames in a scene, where the second frame is subsequent to the first frame in the plurality of frames. The motion component 198 may also be configured to perform a block matching procedure for a set of first blocks in the first frame and a set of second blocks in the second frame, where a set of first motion vectors and a set of second motion vectors are calculated based on the block matching procedure. The motion component 198 may also be configured to calculate a set of first motion vectors in the first frame and a set of second motion vectors in the second frame, where the set of first motion vectors and the set of second motion vectors are calculated based on a block matching procedure for a set of first blocks in the first frame and a set of second blocks in the second frame, where each of the set of first blocks includes a plurality of first pixels and each of the set of second blocks includes a plurality of second pixels, where the block matching procedure is associated with comparing at least one first block of the set of first blocks to at least one second block of the set of second blocks. The motion component 198 may also be configured to estimate at least one third frame in the plurality of frames based on the set of first motion vectors in the first frame and the set of second motion vectors in the second frame, where the at least one third frame is subsequent to the second frame in the plurality of frames. The motion component 198 may also be configured to transmit the at least one third frame after estimating the at least one third frame, where the at least one third frame is transmitted to a display or a display panel. Although the following description may be focused on display processing, the concepts described herein may be applicable to other similar processing techniques.

As described herein, a device, such as the device 104, may refer to any device, apparatus, or system configured to perform one or more techniques described herein. For example, a device may be a server, a base station, user equipment, a client device, a station, an access point, a computer, e.g., a personal computer, a desktop computer, a laptop computer, a tablet computer, a computer workstation, or a mainframe computer, an end product, an apparatus, a phone, a smart phone, a server, a video game platform or console, a handheld device, e.g., a portable video game device or a personal digital assistant (PDA), a wearable computing device, e.g., a smart watch, an augmented reality device, or a virtual reality device, a non-wearable device, a display or display device, a television, a television set-top box, an intermediate network device, a digital media player, a video streaming device, a content streaming device, an in-car computer, any mobile device, any device configured to generate graphical content, or any device configured to perform one or more techniques described herein. Processes herein may be described as performed by a particular component (e.g., a GPU), but, in further embodiments, may be performed using other components (e.g., a CPU), consistent with disclosed embodiments.

GPUs may process multiple types of data or data packets in a GPU pipeline. For instance, in some aspects, a GPU may process two types of data or data packets, e.g., context register packets and draw call data. A context register packet may be a set of global state information, e.g., information regarding a global register, shading program, or constant data, which may regulate how a graphics context will be processed. For example, context register packets may include information regarding a color format. In some aspects of context register packets, there may be a bit that indicates which workload belongs to a context register. Also, there may be multiple functions or programming running at the same time and/or in parallel. For example, functions or programming may describe a certain operation, e.g., the color mode or color format. Accordingly, a context register may define multiple states of a GPU.

Context states may be utilized to determine how an individual processing unit functions, e.g., a vertex fetcher (VFD), a vertex shader (VS), a shader processor, or a geometry processor, and/or in what mode the processing unit functions. In order to do so, GPUs may use context registers and programming data. In some aspects, a GPU may generate a workload, e.g., a vertex or pixel workload, in the pipeline based on the context register definition of a mode or state. Certain processing units, e.g., a VFD, may use these states to determine certain functions, e.g., how a vertex is assembled. As these modes or states may change, GPUs may need to change the corresponding context. Additionally, the workload that corresponds to the mode or state may follow the changing mode or state.

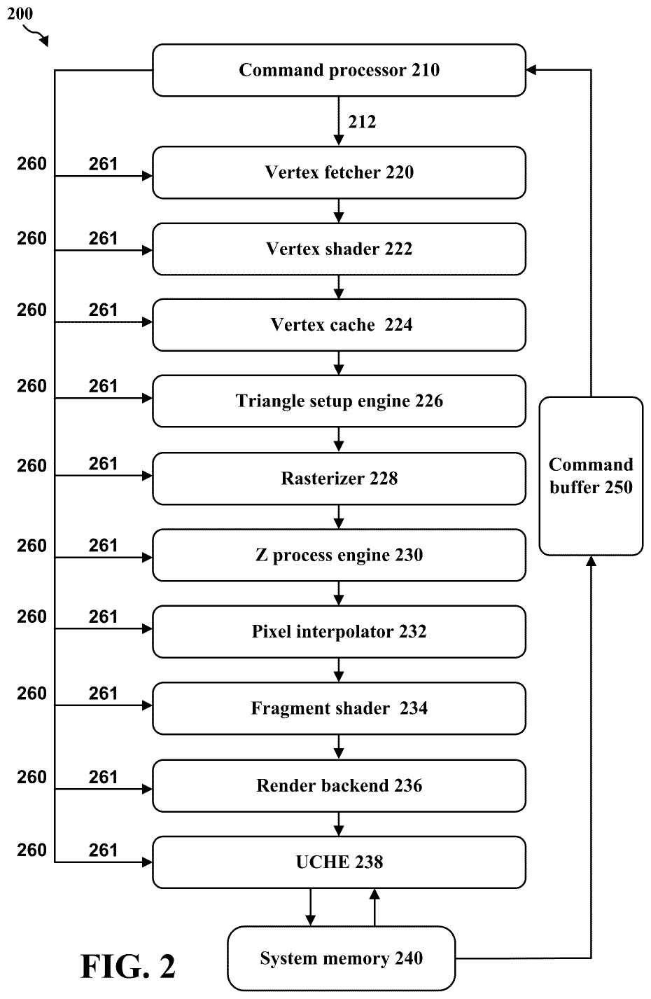

FIG. 2 illustrates an example GPU 200 in accordance with one or more techniques of this disclosure. As shown in FIG. 2, GPU 200 includes command processor (CP) 210, draw call packets 212, VFD 220, VS 222, vertex cache (VPC) 224, triangle setup engine (TSE) 226, rasterizer (RAS) 228, Z process engine (ZPE) 230, pixel interpolator (PI) 232, fragment shader (FS) 234, render backend (RB) 236, level 2 (L2) cache (UCHE) 238, and system memory 240. Although FIG. 2 displays that GPU 200 includes processing units 220-238, GPU 200 may include a number of additional processing units. Additionally, processing units 220-238 are merely an example and any combination or order of processing units may be used by GPUs according to the present disclosure. GPU 200 also includes command buffer 250, context register packets 260, and context states 261.

As shown in FIG. 2, a GPU may utilize a CP, e.g., CP 210, or hardware accelerator to parse a command buffer into context register packets, e.g., context register packets 260, and/or draw call data packets, e.g., draw call packets 212. The CP 210 may then send the context register packets 260 or draw call packets 212 through separate paths to the processing units or blocks in the GPU. Further, the command buffer 250 may alternate different states of context registers and draw calls. For example, a command buffer may be structured in the following manner: context register of context N, draw call(s) of context N, context register of context N+1, and draw call(s) of context N+1.

GPUs may render images in a variety of different ways. In some instances, GPUs may render an image using rendering and/or tiled rendering. In tiled rendering GPUs, an image may be divided or separated into different sections or tiles. After the division of the image, each section or tile may be rendered separately. Tiled rendering GPUs may divide computer graphics images into a grid format, such that each portion of the grid, i.e., a tile, is separately rendered. In some aspects, during a binning pass, an image may be divided into different bins or tiles. In some aspects, during the binning pass, a visibility stream may be constructed where visible primitives or draw calls may be identified. In contrast to tiled rendering, direct rendering does not divide the frame into smaller bins or tiles. Rather, in direct rendering, the entire frame is rendered at a single time. Additionally, some types of GPUs may allow for both tiled rendering and direct rendering.

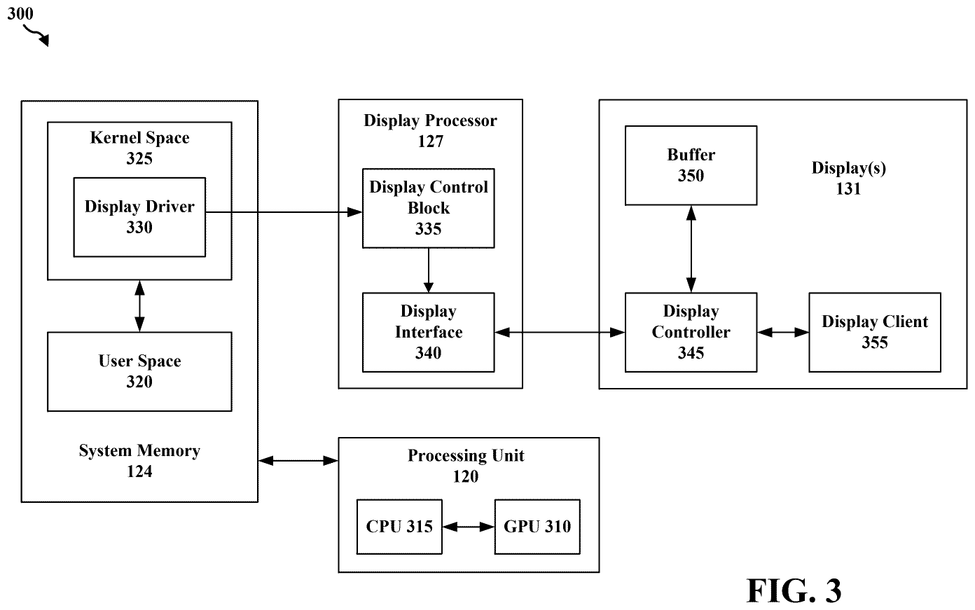

FIG. 3 is a block diagram 300 that illustrates an example display framework including the processing unit 120, the system memory 124, the display processor 127, and the display(s) 131, as may be identified in connection with the device 104.

A GPU may be included in devices that provide content for visual presentation on a display. For example, the processing unit 120 may include a GPU 310 configured to render graphical data for display on a computing device (e.g., the device 104), which may be a computer workstation, a mobile phone, a smartphone or other smart device, an embedded system, a personal computer, a tablet computer, a video game console, and the like. Operations of the GPU 310 may be controlled based on one or more graphics processing commands provided by a CPU 315. The CPU 315 may be configured to execute multiple applications concurrently. In some cases, each of the concurrently executed multiple applications may utilize the GPU 310 simultaneously. Processing techniques may be performed via the processing unit 120 output a frame over physical or wireless communication channels.

The system memory 124, which may be executed by the processing unit 120, may include a user space 320 and a kernel space 325. The user space 320 (sometimes referred to as an “application space”) may include software application(s) and/or application framework(s). For example, software application(s) may include operating systems, media applications, graphical applications, workspace applications, etc. Application framework(s) may include frameworks used by one or more software applications, such as libraries, services (e.g., display services, input services, etc.), application program interfaces (APIs), etc. The kernel space 325 may further include a display driver 330. The display driver 330 may be configured to control the display processor 127. For example, the display driver 330 may cause the display processor 127 to compose a frame and transmit the data for the frame to a display.

The display processor 127 includes a display control block 335 and a display interface 340. The display processor 127 may be configured to manipulate functions of the display(s) 131 (e.g., based on an input received from the display driver 330). The display control block 335 may be further configured to output image frames to the display(s) 131 via the display interface 340. In some examples, the display control block 335 may additionally or alternatively perform post-processing of image data provided based on execution of the system memory 124 by the processing unit 120.

The display interface 340 may be configured to cause the display(s) 131 to display image frames. The display interface 340 may output image data to the display(s) 131 according to an interface protocol, such as, for example, the MIPI DSI (Mobile Industry Processor Interface, Display Serial Interface). That is, the display(s) 131, may be configured in accordance with MIPI DSI standards. The MIPI DSI standard supports a video mode and a command mode. In examples where the display(s) 131 is/are operating in video mode, the display processor 127 may continuously refresh the graphical content of the display(s) 131. For example, the entire graphical content may be refreshed per refresh cycle (e.g., line-by-line). In examples where the display(s) 131 is/are operating in command mode, the display processor 127 may write the graphical content of a frame to a buffer 350.

In some such examples, the display processor 127 may not continuously refresh the graphical content of the display(s) 131. Instead, the display processor 127 may use a vertical synchronization (Vsync) pulse to coordinate rendering and consuming of graphical content at the buffer 350. For example, when a Vsync pulse is generated, the display processor 127 may output new graphical content to the buffer 350. Thus, generation of the Vsync pulse may indicate that current graphical content has been rendered at the buffer 350.

Frames are displayed at the display(s) 131 based on a display controller 345, a display client 355, and the buffer 350. The display controller 345 may receive image data from the display interface 340 and store the received image data in the buffer 350. In some examples, the display controller 345 may output the image data stored in the buffer 350 to the display client 355. Thus, the buffer 350 may represent a local memory to the display(s) 131. In some examples, the display controller 345 may output the image data received from the display interface 340 directly to the display client 355.

The display client 355 may be associated with a touch panel that senses interactions between a user and the display(s) 131. As the user interacts with the display(s) 131, one or more sensors in the touch panel may output signals to the display controller 345 that indicate which of the one or more sensors have sensor activity, a duration of the sensor activity, an applied pressure to the one or more sensor, etc. The display controller 345 may use the sensor outputs to determine a manner in which the user has interacted with the display(s) 131. The display(s) 131 may be further associated with/include other devices, such as a camera, a microphone, and/or a speaker, that operate in connection with the display client 355.

Some processing techniques of the device 104 may be performed over three stages (e.g., stage 1: a rendering stage; stage 2: a composition stage; and stage 3: a display/transfer stage). However, other processing techniques may combine the composition stage and the display/transfer stage into a single stage, such that the processing technique may be executed based on two total stages (e.g., stage 1: the rendering stage; and stage 2: the composition/display/transfer stage). During the rendering stage, the GPU 310 may process a content buffer based on execution of an application that generates content on a pixel-by-pixel basis. During the composition and display stage(s), pixel elements may be assembled to form a frame that is transferred to a physical display panel/subsystem (e.g., the displays 131) that displays the frame.

Instructions executed by a CPU (e.g., software instructions) or a display processor may cause the CPU or the display processor to search for and/or generate a composition strategy for composing a frame based on a dynamic priority and runtime statistics associated with one or more composition strategy groups. A frame to be displayed by a physical display device, such as a display panel, may include a plurality of layers. Also, composition of the frame may be based on combining the plurality of layers into the frame (e.g., based on a frame buffer). After the plurality of layers are combined into the frame, the frame may be provided to the display panel for display thereon. The process of combining each of the plurality of layers into the frame may be referred to as composition, frame composition, a composition procedure, a composition process, or the like.

A frame composition procedure or composition strategy may correspond to a technique for composing different layers of the plurality of layers into a single frame. The plurality of layers may be stored in doubled data rate (DDR) memory. Each layer of the plurality of layers may further correspond to a separate buffer. A composer or hardware composer (HWC) associated with a block or function may determine an input of each layer/buffer and perform the frame composition procedure to generate an output indicative of a composed frame. That is, the input may be the layers and the output may be a frame composition procedure for composing the frame to be displayed on the display panel.

Some aspects of display processing may utilize different types of mask layers, e.g., a shape mask layer. A mask layer is a layer that may represent a portion of a display or display panel. For instance, an area of a mask layer may correspond to an area of a display, but the entire mask layer may depict a portion of the content that is actually displayed at the display or panel. For example, a mask layer may include a top portion and a bottom portion of a display area, but the middle portion of the mask layer may be empty. In some examples, there may be multiple mask layers to represent different portions of a display area. Also, for certain portions of a display area, the content of different mask layers may overlap with one another. Accordingly, a mask layer may represent a portion of a display area that may or may not overlap with other mask layers.

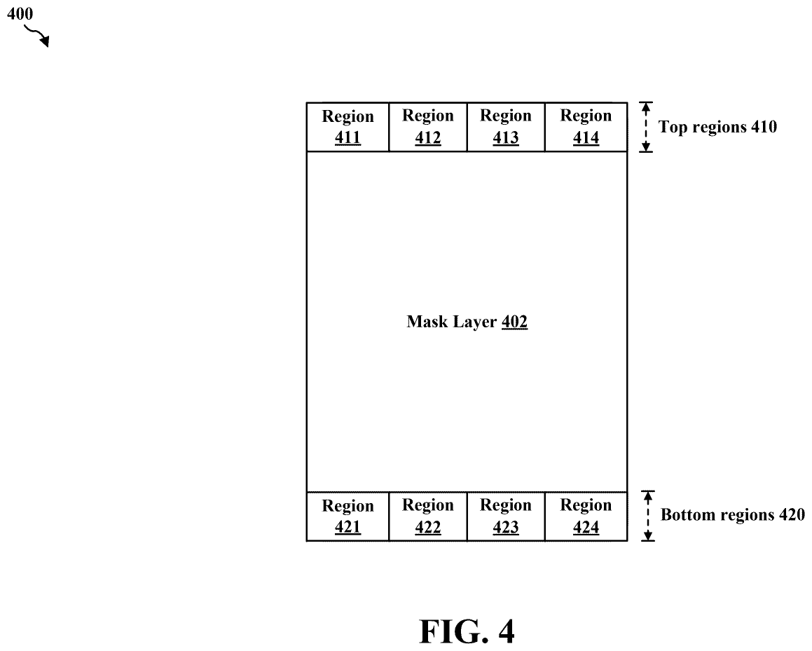

FIG. 4 is a diagram 400 illustrating an example mask layer for display processing. More specifically, diagram 400 depicts one type of mask layer that may represent portions of a display panel. As shown in FIG. 4, diagram 400 includes mask layer 402 including top regions 410 and bottom regions 420. Top regions 410 include region 411, region 412, region 413, and region 414, and bottom regions 420 include region 421, region 422, region 423, and region 424. As depicted in FIG. 4, mask layer 402 may represent the different regions that are displayed on a display panel.

Some types of displays may use a certain type of mask layer (e.g., a shape mask layer) to reshape a display frame. For instance, a mask layer may reshape the display frame to provide more optimized visual shapes at the display panel (e.g., improved round corners, improved circular shape, improved rectangular shape, etc.). These types of mask layers (e.g., shape mask layers) may be processed by software (e.g., graphics processing unit (GPU) software or central processing unit (CPU) software) or by hardware (e.g., display processing unit (DPU) hardware). Also, these mask layers may be processed by other specific types of hardware logic modules (e.g., modules in a display driver integrated circuit (DDIC) or bridge chips). In some aspects, these types of mask layers (e.g., shape mask layers) may be based on certain unit, such as a pixel. That is, the shape generation basis unit of the shape mask layers may be a single pixel.

Aspects of graphics processing may be associated with different applications, e.g., extended reality (XR), augmented reality (AR), or virtual reality (VR) applications. XR, AR, or VR systems utilized with certain devices (e.g., mobile devices or smartphones) are under demanding constraints for power and performance efficiency. In order to alleviate these constraints, motion estimation may be performed on previously rendered content and used to extrapolate frames. For example, instead of rendering a frame, previously rendered frames may be used to estimate motion. In turn, motion estimation may allow the rendering operations to run at a reduced frame rate. This frame extrapolation may also be utilized for streaming remote game rendering, such as to cover for intermittent network issues and/or bandwidth constraints.

Motion estimation may work well at times, however, the content may be discontinuous when transitioning between frames, such as on a frame-by-frame basis. For instance, certain actions within applications (e.g., when a user teleports in a gaming application) may result in discontinuous content between frames. In these instances, performing motion estimation may result in inaccurate data (e.g., inaccurate or spurious motion estimation data) based on the discontinuous content between frames. This inaccurate data may result in a poor attempt to extrapolate the frame based on the motion estimation. Certain types of content may result in the aforementioned discontinuities between frames. For example, user interface (UI) elements or menus, such as those that pop open or change content in a single frame, may be discontinuous frame-to-frame. Certain camera transitions that occur in a single frame, such as a teleport XR locomotion mechanic, may also be discontinuous frame-to-frame. Further, snap turns which rotate the camera a large amount in a single frame may be discontinuous frame-to-frame. Effects which add immediate transparent overlays or changes in brightness may also be discontinuous frame-to-frame. Additionally, rapid controller movements may be discontinuous frame-to-frame.

Power in mobile devices may be a restriction to prevent end-users from running high frame-rate games/applications (e.g., 90 Hz or 120 Hz) for a long period of time. For example, rendering at 120 Hz or more frames is a challenge to mobile devices and desktop devices. Frame rate up-conversion by frames extrapolation may take on the challenge of high frame-rate gaming on mobile devices with a good balance of device power, performance, smoothness, and frames-per-second (FPS). For example, native rendering of 60 Hz and frame extrapolation to 120 Hz may be a good practice. Indeed, as games/applications utilize higher FPS, frame extrapolation may be used to balance power, performance, smoothness, and FPS.

Frame extrapolations may be based on motion vector estimation and/or motion compensation. In a motion estimation stage, frame extrapolation may use two existing input frames to calculate a motion vector from one frame to the other frame for each block. Then, in a motion compensation stage, a new frame may be extrapolated from the base frame and its motion vectors. For example, in a motion estimation stage, frame extrapolation may utilize input frame N−1 and input frame N to calculate a motion vector from frame N−1 to frame N for each block. In the motion compensation stage, a new frame N+1 may be extrapolated from the base frame N and its motion vectors.

Additionally, block matching is a procedure that may be used to estimate/calculate motion vectors to determine a best matched block. For instance, block matching may be applied on each block of a target frame in order to determine a best matched block in a reference frame. Block matching may perform a full range search to find the best matched block in a reference frame in order to reduce the cost of the motion estimation. The estimated/calculated motion vectors may be the translation from a current block to a best matched block.

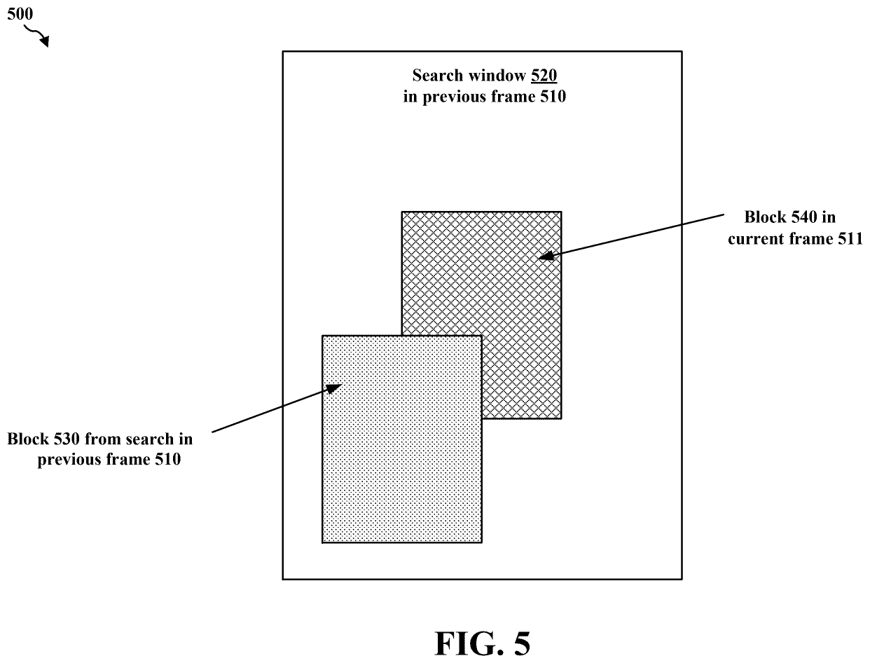

FIG. 5 is a diagram 500 illustrating an example block matching procedure for graphics processing. More specifically, diagram 500 depicts an example of a block matching procedure to generate motion vectors for frame extrapolation. As shown in FIG. 5, diagram 500 includes previous frame 510, current frame 511, search window 520, block 530, and block 540. FIG. 5 depicts the search window 520 in previous frame 510. Also, block 530 and block 540 may be within the search window 520. As illustrated in FIG. 5, block 530 is from the search in previous frame 510, and block 540 is in current frame 511. FIG. 5 depicts that a block matching procedure for block 530 and block 540 may be used to generate motion vectors for frame extrapolation.

In some aspects, block matching may fail to estimate correct motion vectors and/or fail to correctly report object deformation. For instance, some block matching algorithms may have accuracy limitations. Also, block matching-based algorithms may rely on raw pixel value matching, but may have no understanding of real game/application content (e.g., objects, scene, characters, etc.). Accordingly, block matching may cause unexpected artifacts in the generated frames in certain situations. For example, block matching motion vector errors/limitations may be accepted by video encoding-decoding systems and computer vision (CV) systems (e.g., artificial intelligence (AI)). Additionally, real time game frame extrapolation may have different motion estimations specifications compared to video encoder-decoder and AI-CV scenarios. Also, smartphone vendors and game vendors may desire corresponding solutions to these issues. Block matching motion vector errors/limitations may also equate to a bad experience for real-time game/application frame extrapolations. Further, motion vector errors may lead to a deformation in game objects, which may result in noticeable game flickers and deformation. Based on the above, it may be beneficial to utilize block matching procedures that address the aforementioned issues.

Aspects of the present disclosure may utilize block matching procedures that address the aforementioned issues. For instance, aspects of the present disclosure may utilize depth information in block matching procedures in order to distinguish objects in a scene. For example, the depth information in block matching procedures may help to distinguish different objects within backgrounds and foregrounds of frames in a scene. Further, aspects presented herein may add a new test block (e.g., a Z-test block) to blocking matching algorithms. By doing so, aspects presented herein may help to solve the issue of object deformation in graphics processing. Also, aspects of the present disclosure may use a depth map buffer to guide block searching in block matching. For instance, aspects presented herein may help to provide accurate depth information (e.g., Z information). This depth information may not be available in video encoder-decoder and computer vision block matching scenarios. Further, aspects presented herein may provide an accurate pixel/fragment depth buffer and Z-test, such as for a GPU rendering pipeline. For frame extrapolation of sequential frames, the paired matched blocks may indicate fragments/pixels of a same object. These pixels/fragments Z-axis and depth values may be the same or similar. Further, the Z-axis of the paired matched blocks may be the same or similar.

Aspects presented herein may use a color buffer and/or a depth buffer for motion vector calculations. For instance, aspects of the present disclosure may utilize a color buffer and/or a depth buffer (e.g., a low-resolution Z-buffer in a GPU hardware cache) for multiple frames (e.g., frame N−1 and frame N) in a scene for a motion vector calculation. Also, a Z-test block may be added before certain calculations during a block searching procedure. For example, a Z-test block may be added before a block similarity computation (e.g., a mean absolute deviation (MAD) calculation and/or a mean squared error (MSE) calculation) for multiple blocks during a block searching procedure. In some instances, if a depth difference between the blocks is larger than a threshold, aspects presented herein may skip a current search and continue performing a subsequent search. Otherwise, aspects presented herein may compare a cost function (e.g., a MAD/MSE calculation), and then update a minimum cost function (e.g., a MAD/MSE calculation) value and/or a minimum motion vector. The depth difference threshold may be obtained by a clustering analysis on a depth buffer (e.g., a frame N depth buffer) or other run-time depth buffer analysis. Aspects presented herein may utilize both color and depth buffers (e.g., a low-resolution Z-buffer in a GPU hardware cache) for multiple frames (e.g., frame N−1 and frame N) for motion vector estimation. If the depth difference between these frames is larger than a threshold, aspects presented herein may skip a current search and continue the next search. If the depth difference between these frames is not larger than a threshold, aspects presented herein may compare a cost function (e.g., MAD/MSE calculation), and update a minimum cost function (e.g., MAD/MSE calculation) value and/or minimum motion vector.

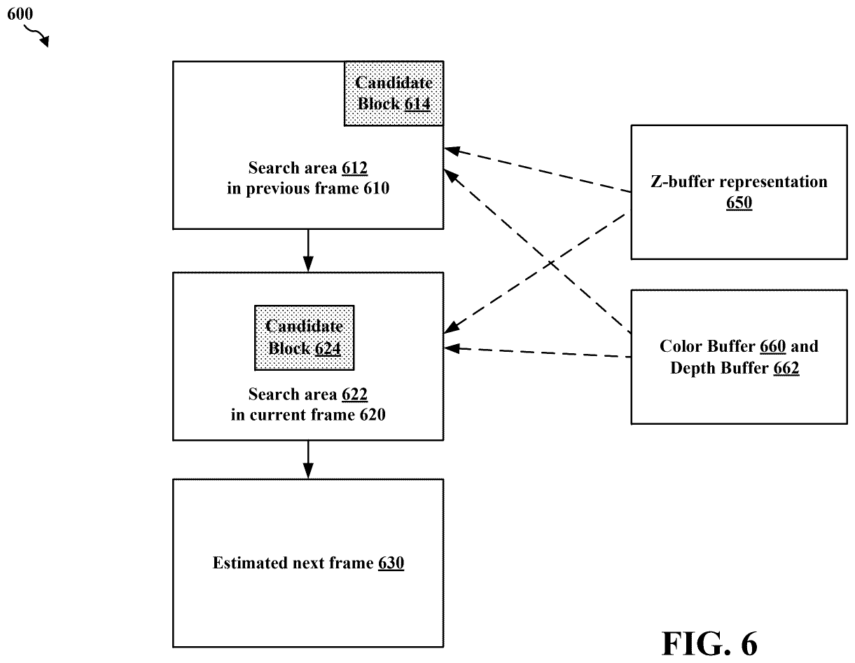

FIG. 6 is a diagram 600 illustrating an example block matching procedure for graphics processing. More specifically, diagram 600 depicts a block matching procedure utilizing a Z-test block and color/depth buffers. As shown in FIG. 6, diagram 600 includes previous frame 610, search area 612, candidate block 614, current frame 620, search area 622, candidate block 624, next frame 630, Z-buffer representation 650, color buffer 660, and depth buffer 662. FIG. 6 depicts that Z-buffer representation 650, color buffer 660, and depth buffer 662 are utilized during the block matching procedure for candidate block 614 and candidate block 624. As illustrated in FIG. 6, previous frame 610 and current frame 620 may first be obtained from multiple frames. After this, a set of first motion vectors in previous frame 610 may be calculated and a set of second motion vectors in current frame 620 may be calculated. These motion vectors in previous frame 610 and current frame 620 may be calculated based on a block matching procedure for a set of first blocks in previous frame 610 and a set of second blocks in current frame 620. Each of the blocks in previous frame 610 and current frame 620 may include multiple pixels. Also, next frame 630 may be estimated based on the calculated motion vectors in previous frame 610 and the calculated motion vectors in current frame 620.

As indicated herein, to calculate the motion vectors in previous frame 610 and current frame 620, a block matching procedure may be performed for the blocks in previous frame 610 (including candidate block 614) and the blocks in current frame 620 (including candidate block 624). To perform the block matching procedure, aspects presented herein may compare the candidate block 614 in previous frame 610 and the candidate block 624 in current frame 620. Also, to compare the candidate block 614 in previous frame 610 and the candidate block 624 in current frame 620, aspects presented herein may compare a first depth coordinate for at least one pixel in candidate block 614 to a second depth coordinate for at least one pixel in candidate block 624. Moreover, to compare a first depth coordinate for at least one pixel in candidate block 614 to a second depth coordinate for at least one pixel in candidate block 624, aspects presented herein may determine whether a difference in the first depth coordinate for the at least one pixel in candidate block 614 and the second depth coordinate for the at least one corresponding pixel in candidate block 624 is greater than a depth threshold. In some aspects, if a difference in the first depth coordinate and the second depth coordinate is greater than a depth threshold, aspects presented herein may refrain from further comparing candidate block 614 to candidate block 624; and then compare the candidate block 614 to at least one third block. The depth threshold may be based on a clustering analysis on previous frame 610 or current frame 620 that is associated with a depth buffer, or the depth threshold may be based on a run-time frame depth buffer analysis associated with the depth buffer. Additionally, to compare a first depth coordinate for at least one pixel in candidate block 614 to a second depth coordinate for at least one pixel in candidate block 624, aspects presented herein may perform a depth test or Z-test (e.g., with Z-buffer representation 650) for the pixels in candidate block 614 and the pixels in candidate block 624. In some instances, to compare the candidate block 614 in previous frame 610 and the candidate block 624 in current frame 620, aspects presented herein may identify a selected first block (e.g., candidate block 614) in previous frame 610 that is most similar to a selected second block (e.g., candidate block 624) in current frame 620.

As shown in FIG. 6, the set of motion vectors in previous frame 610 and/or current frame 620 may be calculated based on color buffer 660 and/or depth buffer 662. Further, the set of motion vectors in current frame 620 may be calculated based on color buffer 660 and/or depth buffer 662. The color buffer 660 may be one color buffer or multiple color buffers, and the depth buffer 662 may be one depth buffer or multiple depth buffers. The depth buffer 662 may be a first Z-buffer and a second Z-buffer, where the first Z-buffer and the second Z-buffer are in at least one of: a graphics processing unit (GPU) hardware cache, a double data rate (DDR) memory, or a system memory. The first Z-buffer (e.g., depth buffer 662) may be a first full resolution buffer or a first low resolution buffer, and the second Z-buffer (e.g., depth buffer 662) may be a second full resolution buffer or a second low resolution buffer.

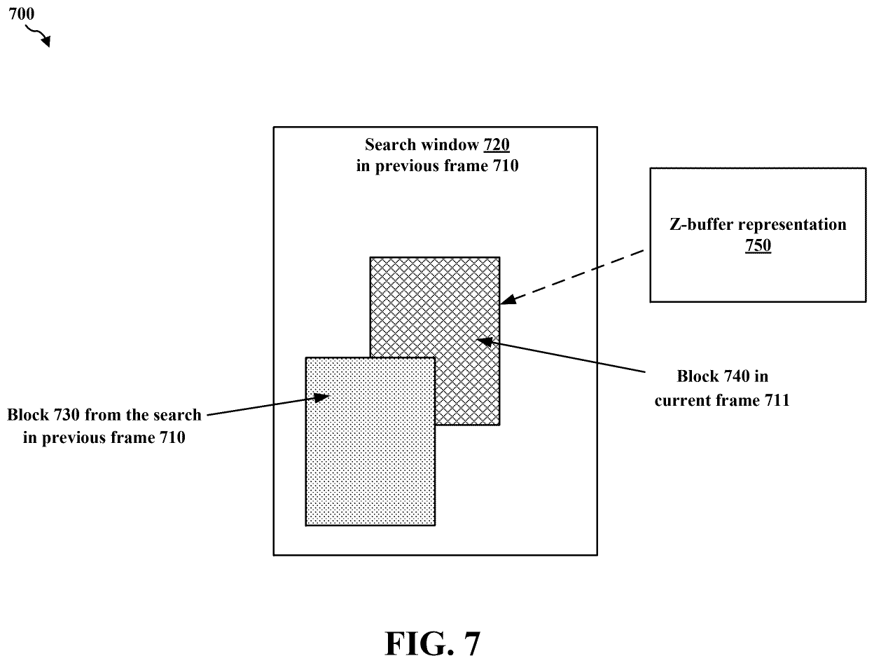

FIG. 7 is a diagram 700 illustrating an example block matching procedure for graphics processing. More specifically, diagram 700 depicts an example of a block matching procedure to generate motion vectors for frame extrapolation. As shown in FIG. 7, diagram 700 includes previous frame 710, current frame 711, search window 720, block 730, block 740, and Z-buffer representation 750. FIG. 7 depicts the search window 720 in previous frame 710, where block 730 and block 740 are within the search window 720. As illustrated in FIG. 7, block 730 is from the search in previous frame 710, and block 740 is in current frame 711. FIG. 7 depicts that a block matching procedure for block 730 and block 740, including Z-buffer representation 750, may be used to generate motion vectors for frame extrapolation. That is, FIG. 7 illustrates that a depth test block (e.g., a Z-test block) or a depth buffer (e.g., a Z-buffer representation 750) may be used in a block matching procedure for block 730 and block 740. For instance, a Z-test block (e.g., a Z-buffer representation 750) may be added to a block matching algorithm in order to perform a more accurate block matching procedure. The block matching procure steps described in association with FIG. 6 for candidate block 614 in previous frame 610 and candidate block 624 in current frame 620 may likewise be utilized in association with FIG. 7 for block 730 in previous frame 710 and block 740 in current frame 711.

As illustrated in FIG. 7, previous frame 710 and current frame 711 may first be obtained from multiple frames. After this, a set of first motion vectors in previous frame 710 may be calculated and a set of second motion vectors in current frame 711 may be calculated. These motion vectors in previous frame 710 and current frame 711 may be calculated based on a block matching procedure for a set of first blocks in previous frame 710 and a set of second blocks in current frame 711. Each of the blocks in previous frame 710 and current frame 711 may include multiple pixels. Also, a next frame may be estimated based on the calculated motion vectors in previous frame 710 and the calculated motion vectors in current frame 711.

As indicated herein, to calculate the motion vectors in previous frame 710 and current frame 711, a block matching procedure may be performed for the blocks in previous frame 710 (including block 730) and the blocks in current frame 711 (including block 740). To perform the block matching procedure, aspects presented herein may compare the block 730 in previous frame 710 and the block 740 in current frame 711. Also, to compare the block 730 in previous frame 710 and the block 740 in current frame 711, aspects presented herein may compare a first depth coordinate for at least one pixel in block 730 to a second depth coordinate for at least one pixel in block 740. Moreover, to compare a first depth coordinate for at least one pixel in block 730 to a second depth coordinate for at least one pixel in block 740, aspects presented herein may determine whether a difference in the first depth coordinate for the at least one pixel in block 730 and the second depth coordinate for the at least one corresponding pixel in block 740 is greater than a depth threshold. In some aspects, if a difference in the first depth coordinate and the second depth coordinate is greater than a depth threshold, aspects presented herein may refrain from further comparing block 730 to block 740; and then compare the block 730 to at least one third block. The depth threshold may be based on a clustering analysis on previous frame 710 or current frame 711 that is associated with a depth buffer, or the depth threshold may be based on a run-time frame depth buffer analysis associated with the depth buffer. Additionally, to compare a first depth coordinate for at least one pixel in block 730 to a second depth coordinate for at least one pixel in block 740, aspects presented herein may perform a depth test or Z-test (e.g., with Z-buffer representation) for the pixels in block 730 and the pixels in block 740. In some instances, to compare the block 730 in previous frame 710 and the block 740 in current frame 711, aspects presented herein may identify a selected first block (e.g., block 730) in previous frame 710 that is most similar to a selected second block (e.g., block 740) in current frame 711.

As shown in FIG. 7, the set of motion vectors in previous frame 710 and/or current frame 711 may be calculated based on a color buffer and/or depth buffer. Further, the set of motion vectors in current frame may be calculated based on a color buffer and/or depth buffer. The color buffer may be one color buffer or multiple color buffers, and the depth buffer may be one depth buffer or multiple depth buffers. The depth buffer may be a first Z-buffer and a second Z-buffer, where the first Z-buffer and the second Z-buffer are in at least one of: a graphics processing unit (GPU) hardware cache, a double data rate (DDR) memory, or a system memory. The first Z-buffer (e.g., depth buffer) may be a first full resolution buffer or a first low resolution buffer, and the second Z-buffer (e.g., depth buffer) may be a second full resolution buffer or a second low resolution buffer.

Aspects of the present disclosure may include a number of benefits or advantages. For instance, aspects of the present disclosure may reduce the failure rates of block matching by using depth information to distinguish different objects in backgrounds and foregrounds of frames in a scene. Also, aspects presented herein may improve the power and/or performance of block matching procedures by adding a Z-test block in block searching. For example, aspects presented herein may add a Z-test block to blocking matching algorithms. This Z-test block or depth buffer may be a novel solution when used in conjunction with the block matching procedure. By adding a Z-test block for block searching, aspects presented herein may perform an improvement in frame motion estimation and interpolation/extrapolation for GPUs. Indeed, aspects presented herein may provide a more accurate frame motion estimation and interpolation/extrapolation, as well as a reduce the amount of power utilized for frame motion estimations and interpolations/extrapolations.

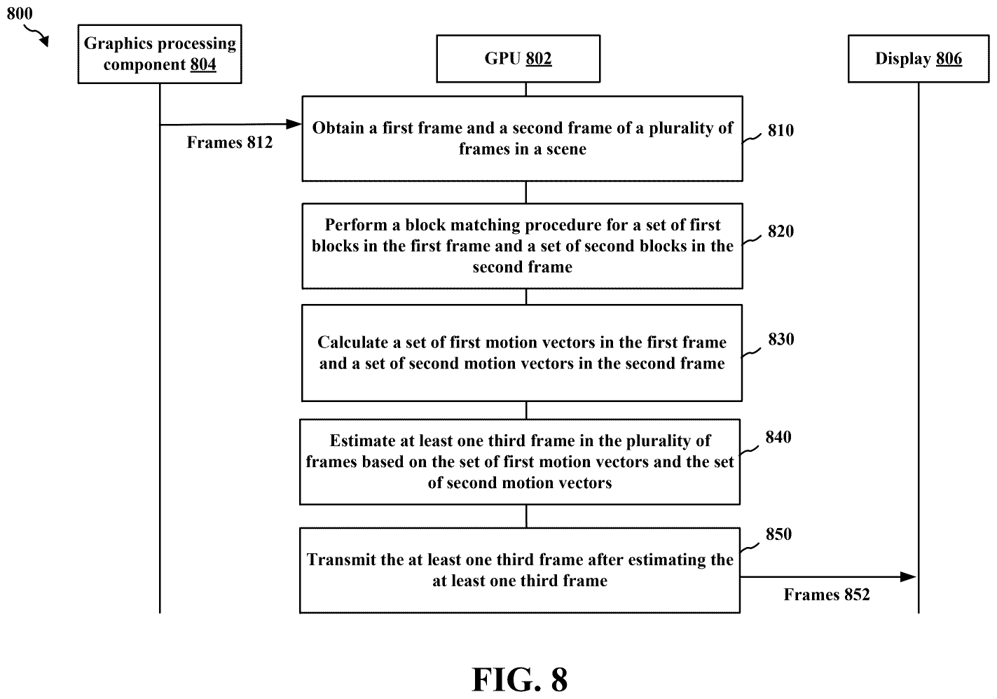

FIG. 8 is a communication flow diagram 800 of graphics processing in accordance with one or more techniques of this disclosure. As shown in FIG. 8, diagram 800 includes example communications between GPU 802, graphics processing component 804 (e.g., a component in a graphics processing operation), and display 806 (e.g., a display panel or display processor), in accordance with one or more techniques of this disclosure.

At 810, GPU 802 may obtain a first frame and a second frame of a plurality of frames in a scene (e.g., GPU 802 may obtain frames 812 from graphics processing component 804), where the second frame is subsequent to the first frame in the plurality of frames. The scene may be associated with the graphics processing, computer vision processing, or artificial intelligence (AI) processing, and the block matching procedure may be a block searching procedure for the graphics processing, the computer vision processing, or the AI processing.

At 820, GPU 802 may perform a block matching procedure for a set of first blocks in the first frame and a set of second blocks in the second frame, where a set of first motion vectors and a set of second motion vectors are calculated based on the block matching procedure. In some aspects, performing the block matching procedure may include comparing the at least one first block of the set of first blocks to the at least one second block of the set of second blocks. That is, the GPU 802 may compare the at least one first block of the set of first blocks to the at least one second block of the set of second blocks. Also, comparing the at least one first block of the set of first blocks to the at least one second block of the set of second blocks may include comparing a first depth coordinate for at least one first pixel of a set of first pixels in the at least one first block to a second depth coordinate for at least one corresponding second pixel of a set of second pixels in the at least one second block. That is, the GPU 802 may compare a first depth coordinate for at least one first pixel of a set of first pixels in the at least one first block to a second depth coordinate for at least one corresponding second pixel of a set of second pixels in the at least one second block. In some instances, comparing the first depth coordinate for the at least one first pixel of the set of first pixels to the second depth coordinate for the at least one corresponding second pixel of the set of second pixels may include determining whether a difference in the first depth coordinate for each pixel of the set of first pixels and the second depth coordinate for the at least one corresponding second pixel of the set of second pixels is greater than a depth threshold. That is, the GPU 802 may determine whether a difference in the first depth coordinate for each pixel of the set of first pixels and the second depth coordinate for the at least one corresponding second pixel of the set of second pixels is greater than a depth threshold. In some aspects, comparing the first depth coordinate for the at least one first pixel of the set of first pixels to the second depth coordinate for the at least one corresponding second pixel of the set of second pixels may include performing a Z-test for the set of first pixels and the set of second pixels. That is, the GPU 802 may perform a Z-test for the set of first pixels and the set of second pixels. In some aspects, if a difference in the first depth coordinate for the at least one first pixel and the second depth coordinate for the at least one corresponding second pixel is greater than a depth threshold, the GPU 802 may refrain from comparing the at least one first block to the at least one second block; and compare the at least one first block of the set of first blocks to at least one third block of a set of third blocks. The depth threshold may be based on a clustering analysis on at least one frame associated with a depth buffer, or the depth threshold may be based on a run-time frame depth buffer analysis associated with the depth buffer. Also, comparing the at least one first block of the set of first blocks to the at least one second block of the set of second blocks may include identifying a selected first block in the set of first blocks that is most similar to a selected second block in the set of second blocks. That is, the GPU 802 may identify a selected first block in the set of first blocks that is most similar to a selected second block in the set of second blocks.

At 830, GPU 802 may calculate a set of first motion vectors in the first frame and a set of second motion vectors in the second frame, where the set of first motion vectors and the set of second motion vectors are calculated based on a block matching procedure for a set of first blocks in the first frame and a set of second blocks in the second frame, where each of the set of first blocks includes a plurality of first pixels and each of the set of second blocks includes a plurality of second pixels, where the block matching procedure is associated with comparing at least one first block of the set of first blocks to at least one second block of the set of second blocks. The block matching procedure may be associated with a comparison of first depth coordinate for at least one first pixel of a set of first pixels in the at least one first block to a second depth coordinate for at least one corresponding second pixel of a set of second pixels in the at least one second block. In some aspects, the set of first motion vectors may be calculated based on at least one of a first color buffer or a first depth buffer associated with the first frame, and the set of second motion vectors may be calculated based on at least one of a second color buffer or a second depth buffer associated with the second frame. The first depth buffer may be a first Z-buffer and the second depth buffer is a second Z-buffer, where the first Z-buffer and the second Z-buffer may be in at least one of: a graphics processing unit (GPU) hardware cache, a double data rate (DDR) memory, or a system memory. The first Z-buffer may be a first full resolution buffer or a first low resolution buffer, and the second Z-buffer may be a second full resolution buffer or a second low resolution buffer.

At 840, GPU 802 may estimate at least one third frame in the plurality of frames based on the set of first motion vectors in the first frame and the set of second motion vectors in the second frame, where the at least one third frame is subsequent to the second frame in the plurality of frames.

At 850, GPU 802 may transmit the at least one third frame after estimating the at least one third frame, where the at least one third frame is transmitted to a display or a display panel (e.g., GPU 802 may transmit frames 852 to display 806).

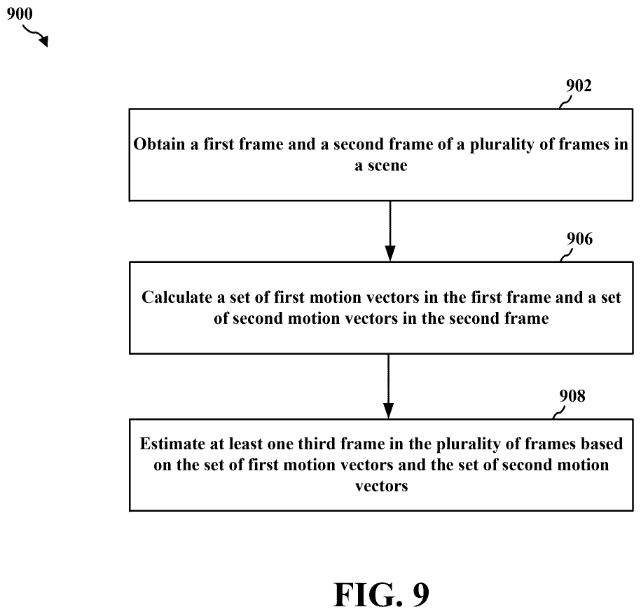

FIG. 9 is a flowchart 900 of an example method of display processing in accordance with one or more techniques of this disclosure. The method may be performed by a GPU (or other graphics processor), a CPU (or other central processor), a digital signal processor (DSP), a DPU (or other display processor), a DDIC, an apparatus for graphics processing, a wireless communication device, and/or any apparatus that may perform display processing as used in connection with the examples of FIGS. 1-8.

At 902, the GPU may obtain a first frame and a second frame of a plurality of frames in a scene, where the second frame is subsequent to the first frame in the plurality of frames, as described in connection with the examples in FIGS. 1-8. For example, as described in 810 of FIG. 8, GPU 802 may obtain a first frame and a second frame of a plurality of frames in a scene, where the second frame is subsequent to the first frame in the plurality of frames. Further, step 902 may be performed by processing unit 120 in FIG. 1. The scene may be associated with the graphics processing, computer vision processing, or artificial intelligence (AI) processing, and the block matching procedure may be a block searching procedure for the graphics processing, the computer vision processing, or the AI processing.

At 906, the GPU may calculate a set of first motion vectors in the first frame and a set of second motion vectors in the second frame, where the set of first motion vectors and the set of second motion vectors are calculated based on a block matching procedure for a set of first blocks in the first frame and a set of second blocks in the second frame, where each of the set of first blocks includes a plurality of first pixels and each of the set of second blocks includes a plurality of second pixels, where the block matching procedure is associated with comparing at least one first block of the set of first blocks to at least one second block of the set of second blocks, as described in connection with the examples in FIGS. 1-8. For example, as described in 830 of FIG. 8, GPU 802 may calculate a set of first motion vectors in the first frame and a set of second motion vectors in the second frame, where the set of first motion vectors and the set of second motion vectors are calculated based on a block matching procedure for a set of first blocks in the first frame and a set of second blocks in the second frame, where each of the set of first blocks includes a plurality of first pixels and each of the set of second blocks includes a plurality of second pixels, where the block matching procedure is associated with comparing at least one first block of the set of first blocks to at least one second block of the set of second blocks. Further, step 906 may be performed by processing unit 120 in FIG. 1. The block matching procedure may be associated with a comparison of first depth coordinate for at least one first pixel of a set of first pixels in the at least one first block to a second depth coordinate for at least one corresponding second pixel of a set of second pixels in the at least one second block. In some aspects, the set of first motion vectors may be calculated based on at least one of a first color buffer or a first depth buffer associated with the first frame, and the set of second motion vectors may be calculated based on at least one of a second color buffer or a second depth buffer associated with the second frame. The first depth buffer may be a first Z-buffer and the second depth buffer is a second Z-buffer, where the first Z-buffer and the second Z-buffer may be in at least one of: a graphics processing unit (GPU) hardware cache, a double data rate (DDR) memory, or a system memory. The first Z-buffer may be a first full resolution buffer or a first low resolution buffer, and the second Z-buffer may be a second full resolution buffer or a second low resolution buffer.

At 908, the GPU may estimate at least one third frame in the plurality of frames based on the set of first motion vectors in the first frame and the set of second motion vectors in the second frame, where the at least one third frame is subsequent to the second frame in the plurality of frames, as described in connection with the examples in FIGS. 1-8. For example, as described in 840 of FIG. 8, GPU 802 may estimate at least one third frame in the plurality of frames based on the set of first motion vectors in the first frame and the set of second motion vectors in the second frame, where the at least one third frame is subsequent to the second frame in the plurality of frames. Further, step 908 may be performed by processing unit 120 in FIG. 1.

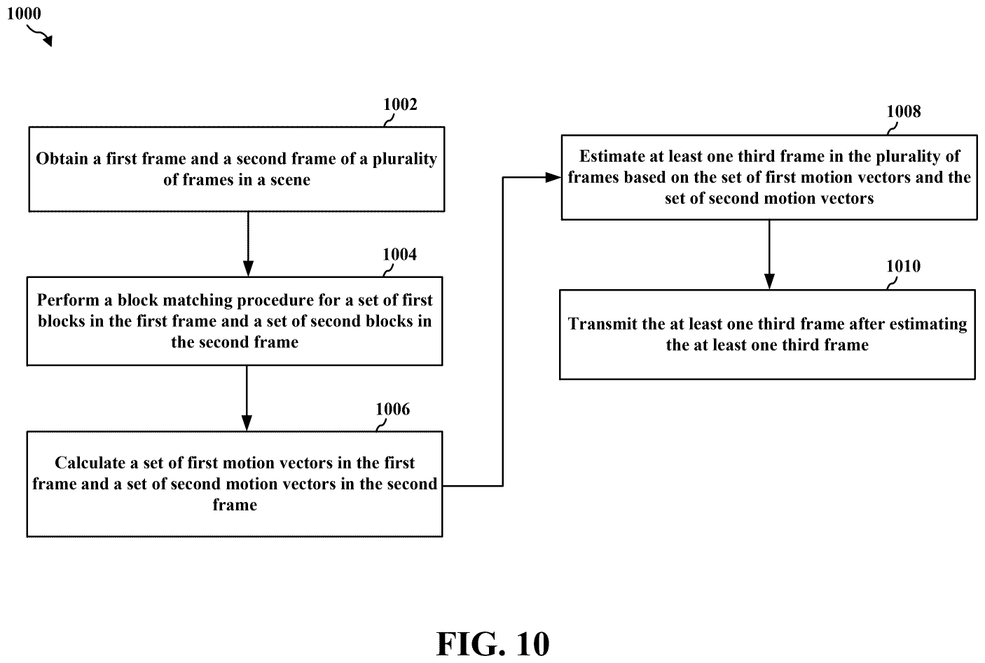

FIG. 10 is a flowchart 1000 of an example method of display processing in accordance with one or more techniques of this disclosure. The method may be performed by a GPU (or other graphics processor), a CPU (or other central processor), a digital signal processor (DSP), a DPU (or other display processor), a DDIC, an apparatus for graphics processing, a wireless communication device, and/or any apparatus that may perform display processing as used in connection with the examples of FIGS. 1-8.

At 1002, the GPU may obtain a first frame and a second frame of a plurality of frames in a scene, where the second frame is subsequent to the first frame in the plurality of frames, as described in connection with the examples in FIGS. 1-8. For example, as described in 810 of FIG. 8, GPU 802 may obtain a first frame and a second frame of a plurality of frames in a scene, where the second frame is subsequent to the first frame in the plurality of frames. Further, step 1002 may be performed by processing unit 120 in FIG. 1. The scene may be associated with the graphics processing, computer vision processing, or artificial intelligence (AI) processing, and the block matching procedure may be a block searching procedure for the graphics processing, the computer vision processing, or the AI processing.

At 1004, the GPU may perform a block matching procedure for a set of first blocks in the first frame and a set of second blocks in the second frame, where a set of first motion vectors and a set of second motion vectors are calculated based on the block matching procedure, as described in connection with the examples in FIGS. 1-8. For example, as described in 820 of FIG. 8, GPU 802 may perform a block matching procedure for a set of first blocks in the first frame and a set of second blocks in the second frame, where a set of first motion vectors and a set of second motion vectors are calculated based on the block matching procedure. Further, step 1004 may be performed by processing unit 120 in FIG. 1. In some aspects, performing the block matching procedure may include comparing the at least one first block of the set of first blocks to the at least one second block of the set of second blocks. That is, the GPU may compare the at least one first block of the set of first blocks to the at least one second block of the set of second blocks. Also, comparing the at least one first block of the set of first blocks to the at least one second block of the set of second blocks may include comparing a first depth coordinate for at least one first pixel of a set of first pixels in the at least one first block to a second depth coordinate for at least one corresponding second pixel of a set of second pixels in the at least one second block. That is, the GPU may compare a first depth coordinate for at least one first pixel of a set of first pixels in the at least one first block to a second depth coordinate for at least one corresponding second pixel of a set of second pixels in the at least one second block. In some instances, comparing the first depth coordinate for the at least one first pixel of the set of first pixels to the second depth coordinate for the at least one corresponding second pixel of the set of second pixels may include determining whether a difference in the first depth coordinate for each pixel of the set of first pixels and the second depth coordinate for the at least one corresponding second pixel of the set of second pixels is greater than a depth threshold. That is, the GPU may determine whether a difference in the first depth coordinate for each pixel of the set of first pixels and the second depth coordinate for the at least one corresponding second pixel of the set of second pixels is greater than a depth threshold. In some aspects, comparing the first depth coordinate for the at least one first pixel of the set of first pixels to the second depth coordinate for the at least one corresponding second pixel of the set of second pixels may include performing a Z-test for the set of first pixels and the set of second pixels. That is, the GPU may perform a Z-test for the set of first pixels and the set of second pixels. In some aspects, if a difference in the first depth coordinate for the at least one first pixel and the second depth coordinate for the at least one corresponding second pixel is greater than a depth threshold, the GPU may refrain from comparing the at least one first block to the at least one second block; and compare the at least one first block of the set of first blocks to at least one third block of a set of third blocks. The depth threshold may be based on a clustering analysis on at least one frame associated with a depth buffer, or the depth threshold may be based on a run-time frame depth buffer analysis associated with the depth buffer. Also, comparing the at least one first block of the set of first blocks to the at least one second block of the set of second blocks may include identifying a selected first block in the set of first blocks that is most similar to a selected second block in the set of second blocks. That is, the GPU may identify a selected first block in the set of first blocks that is most similar to a selected second block in the set of second blocks.

At 1006, the GPU may calculate a set of first motion vectors in the first frame and a set of second motion vectors in the second frame, where the set of first motion vectors and the set of second motion vectors are calculated based on a block matching procedure for a set of first blocks in the first frame and a set of second blocks in the second frame, where each of the set of first blocks includes a plurality of first pixels and each of the set of second blocks includes a plurality of second pixels, where the block matching procedure is associated with comparing at least one first block of the set of first blocks to at least one second block of the set of second blocks, as described in connection with the examples in FIGS. 1-8. For example, as described in 830 of FIG. 8, GPU 802 may calculate a set of first motion vectors in the first frame and a set of second motion vectors in the second frame, where the set of first motion vectors and the set of second motion vectors are calculated based on a block matching procedure for a set of first blocks in the first frame and a set of second blocks in the second frame, where each of the set of first blocks includes a plurality of first pixels and each of the set of second blocks includes a plurality of second pixels, where the block matching procedure is associated with comparing at least one first block of the set of first blocks to at least one second block of the set of second blocks. Further, step 1006 may be performed by processing unit 120 in FIG. 1. The block matching procedure may be associated with a comparison of first depth coordinate for at least one first pixel of a set of first pixels in the at least one first block to a second depth coordinate for at least one corresponding second pixel of a set of second pixels in the at least one second block. In some aspects, the set of first motion vectors may be calculated based on at least one of a first color buffer or a first depth buffer associated with the first frame, and the set of second motion vectors may be calculated based on at least one of a second color buffer or a second depth buffer associated with the second frame. The first depth buffer may be a first Z-buffer and the second depth buffer is a second Z-buffer, where the first Z-buffer and the second Z-buffer may be in at least one of: a graphics processing unit (GPU) hardware cache, a double data rate (DDR) memory, or a system memory. The first Z-buffer may be a first full resolution buffer or a first low resolution buffer, and the second Z-buffer may be a second full resolution buffer or a second low resolution buffer.

At 1008, the GPU may estimate at least one third frame in the plurality of frames based on the set of first motion vectors in the first frame and the set of second motion vectors in the second frame, where the at least one third frame is subsequent to the second frame in the plurality of frames, as described in connection with the examples in FIGS. 1-8. For example, as described in 840 of FIG. 8, GPU 802 may estimate at least one third frame in the plurality of frames based on the set of first motion vectors in the first frame and the set of second motion vectors in the second frame, where the at least one third frame is subsequent to the second frame in the plurality of frames. Further, step 1008 may be performed by processing unit 120 in FIG. 1.

At 1010, the GPU may transmit the at least one third frame after estimating the at least one third frame, where the at least one third frame is transmitted to a display or a display panel, as described in connection with the examples in FIGS. 1-8. For example, as described in 850 of FIG. 8, GPU 802 may transmit the at least one third frame after estimating the at least one third frame, where the at least one third frame is transmitted to a display or a display panel. Further, step 1010 may be performed by processing unit 120 in FIG. 1.

In configurations, a method or an apparatus for display processing is provided. The apparatus may be a GPU (or other graphics processor), a CPU (or other central processor), a DSP, a DPU (or other display processor), a DDIC, an apparatus for graphics processing, and/or some other processor that may perform display processing. In aspects, the apparatus may be the processing unit 120 within the device 104, or may be some other hardware within the device 104 or another device. The apparatus, e.g., processing unit 120, may include means for obtaining a first frame and a second frame of a plurality of frames in a scene, where the second frame is subsequent to the first frame in the plurality of frames. The apparatus, e.g., processing unit 120, may also include means for calculating a set of first motion vectors in the first frame and a set of second motion vectors in the second frame, where the set of first motion vectors and the set of second motion vectors are calculated based on a block matching procedure for a set of first blocks in the first frame and a set of second blocks in the second frame, where each of the set of first blocks includes a plurality of first pixels and each of the set of second blocks includes a plurality of second pixels, where the block matching procedure is associated with comparing at least one first block of the set of first blocks to at least one second block of the set of second blocks. The apparatus, e.g., processing unit 120, may also include means for estimating at least one third frame in the plurality of frames based on the set of first motion vectors in the first frame and the set of second motion vectors in the second frame, where the at least one third frame is subsequent to the second frame in the plurality of frames. The apparatus, e.g., processing unit 120, may also include means for performing the block matching procedure for the set of first blocks in the first frame and the set of second blocks in the second frame, where the set of first motion vectors and the set of second motion vectors are calculated based on the block matching procedure. The apparatus, e.g., processing unit 120, may also include means for transmitting the at least one third frame after estimating the at least one third frame, where the at least one third frame is transmitted to a display or a display panel.

The subject matter described herein may be implemented to realize one or more benefits or advantages. For instance, the described display processing techniques may be used by a GPU, a CPU, a DSP, a DPU, a graphics processor, or some other processor that may perform graphics processing to implement the block searching techniques described herein. This may also be accomplished at a low cost compared to other graphics processing techniques. Moreover, the graphics processing techniques herein may improve or speed up data processing or execution. Further, the graphics processing techniques herein may improve resource or data utilization and/or resource efficiency. Additionally, aspects of the present disclosure may utilize block searching techniques in order to improve memory bandwidth efficiency and/or increase processing speed at a GPU or CPU.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects.

Unless specifically stated otherwise, the term “some” refers to one or more and the term “or” may be interpreted as “and/or” where context does not dictate otherwise. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium.

In accordance with this disclosure, the term “or” may be interpreted as “and/or” where context does not dictate otherwise. Additionally, while phrases such as “one or more” or “at least one” or the like may have been used for some features disclosed herein but not others, the features for which such language was not used may be interpreted to have such a meaning implied where context does not dictate otherwise.

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium. Computer-readable media may include computer data storage media or communication media including any medium that facilitates transfer of a computer program from one place to another. In this manner, computer-readable media generally may correspond to (1) tangible computer-readable storage media, which is non-transitory or (2) a communication medium such as a signal or carrier wave. Data storage media may be any available media that may be accessed by one or more computers or one or more processors to retrieve instructions, code and/or data structures for implementation of the techniques described in this disclosure. By way of example, and not limitation, such computer-readable media may comprise RAM, ROM, EEPROM, CD-ROM or other optical disk storage, magnetic disk storage or other magnetic storage devices. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media. A computer program product may include a computer-readable medium.

The code may be executed by one or more processors, such as one or more digital signal processors (DSPs), general purpose microprocessors, application specific integrated circuits (ASICs), arithmetic logic units (ALUs), field programmable logic arrays (FPGAs), or other equivalent integrated or discrete logic circuitry. Accordingly, the term “processor,” as used herein may refer to any of the foregoing structure or any other structure suitable for implementation of the techniques described herein. Also, the techniques could be fully implemented in one or more circuits or logic elements.

The techniques of this disclosure may be implemented in a wide variety of devices or apparatuses, including a wireless handset, an integrated circuit (IC) or a set of ICs, e.g., a chip set. Various components, modules or units are described in this disclosure to emphasize functional aspects of devices configured to perform the disclosed techniques, but do not necessarily need realization by different hardware units. Rather, as described above, various units may be combined in any hardware unit or provided by a collection of inter-operative hardware units, including one or more processors as described above, in conjunction with suitable software and/or firmware. Accordingly, the term “processor,” as used herein may refer to any of the foregoing structure or any other structure suitable for implementation of the techniques described herein. Also, the techniques may be fully implemented in one or more circuits or logic elements.

The following aspects are illustrative only and may be combined with other aspects or teachings described herein, without limitation.

Aspect 1 is an apparatus for graphics processing, including a memory and at least one processor coupled to the memory and, based at least in part on information stored in the memory, the at least one processor is configured to: obtain a first frame and a second frame of a plurality of frames in a scene, where the second frame is subsequent to the first frame in the plurality of frames; calculate a set of first motion vectors in the first frame and a set of second motion vectors in the second frame, where the set of first motion vectors and the set of second motion vectors are calculated based on a block matching procedure for a set of first blocks in the first frame and a set of second blocks in the second frame, where each of the set of first blocks includes a plurality of first pixels and each of the set of second blocks includes a plurality of second pixels, where the block matching procedure is associated with comparing at least one first block of the set of first blocks to at least one second block of the set of second blocks; and estimate at least one third frame in the plurality of frames based on the set of first motion vectors in the first frame and the set of second motion vectors in the second frame, where the at least one third frame is subsequent to the second frame in the plurality of frames.

Aspect 2 is the apparatus of aspect 1, where the block matching procedure is associated with a comparison of first depth coordinate for at least one first pixel of a set of first pixels in the at least one first block to a second depth coordinate for at least one corresponding second pixel of a set of second pixels in the at least one second block.

Aspect 3 is the apparatus of any of aspects 1 and 2, where the at least one processor is further configured to: perform the block matching procedure for the set of first blocks in the first frame and the set of second blocks in the second frame, where the set of first motion vectors and the set of second motion vectors are calculated based on the block matching procedure.

Aspect 4 is the apparatus of any of aspects 1 to 3, where to perform the block matching procedure, the at least one processor is configured to: compare the at least one first block of the set of first blocks to the at least one second block of the set of second blocks.

Aspect 5 is the apparatus of any of aspects 1 to 4, where to compare the at least one first block of the set of first blocks to the at least one second block of the set of second blocks, the at least one processor is configured to: compare a first depth coordinate for at least one first pixel of a set of first pixels in the at least one first block to a second depth coordinate for at least one corresponding second pixel of a set of second pixels in the at least one second block.

Aspect 6 is the apparatus of any of aspects 1 to 5, where to compare the first depth coordinate for the at least one first pixel of the set of first pixels to the second depth coordinate for the at least one corresponding second pixel of the set of second pixels, the at least one processor is configured to: determine whether a difference in the first depth coordinate for each pixel of the set of first pixels and the second depth coordinate for the at least one corresponding second pixel of the set of second pixels is greater than a depth threshold.

Aspect 7 is the apparatus of any of aspects 1 to 6, where to compare the first depth coordinate for the at least one first pixel of the set of first pixels to the second depth coordinate for the at least one corresponding second pixel of the set of second pixels, the at least one processor is configured to: perform a Z-test for the set of first pixels and the set of second pixels.

Aspect 8 is the apparatus of any of aspects 1 to 7, where if a difference in the first depth coordinate for the at least one first pixel and the second depth coordinate for the at least one corresponding second pixel is greater than a depth threshold, the at least one processor is configured to: refrain from comparing the at least one first block to the at least one second block; and compare the at least one first block of the set of first blocks to at least one third block of a set of third blocks.

Aspect 9 is the apparatus of any of aspects 1 to 8, where the depth threshold is based on a clustering analysis on at least one frame associated with a depth buffer, or where the depth threshold is based on a run-time frame depth buffer analysis associated with the depth buffer.

Aspect 10 is the apparatus of any of aspects 1 to 9, where to compare the at least one first block of the set of first blocks to the at least one second block of the set of second blocks, the at least one processor is configured to: identify a selected first block in the set of first blocks that is most similar to a selected second block in the set of second blocks.

Aspect 11 is the apparatus of any of aspects 1 to 10, where the set of first motion vectors is calculated based on at least one of a first color buffer or a first depth buffer associated with the first frame, and where the set of second motion vectors is calculated based on at least one of a second color buffer or a second depth buffer associated with the second frame.

Aspect 12 is the apparatus of any of aspects 1 to 11, where the first depth buffer is a first Z-buffer and the second depth buffer is a second Z-buffer, where the first Z-buffer and the second Z-buffer are in at least one of: a graphics processing unit (GPU) hardware cache, a double data rate (DDR) memory, or a system memory.

Aspect 13 is the apparatus of any of aspects 1 to 12, where the first Z-buffer is a first full resolution buffer or a first low resolution buffer, and where the second Z-buffer is a second full resolution buffer or a second low resolution buffer.

Aspect 14 is the apparatus of any of aspects 1 to 13, where the at least one processor is further configured to: transmit the at least one third frame after estimating the at least one third frame, where the at least one third frame is transmitted to a display or a display panel.

Aspect 15 is the apparatus of any of aspects 1 to 14, where the scene is associated with the graphics processing, computer vision processing, or artificial intelligence (AI) processing, and where the block matching procedure is a block searching procedure for the graphics processing, the computer vision processing, or the AI processing.

Aspect 16 is the apparatus of any of aspects 1 to 15, where the apparatus is a wireless communication device, further including at least one of an antenna or a transceiver coupled to the at least one processor.

Aspect 17 is a method of display processing for implementing any of aspects 1 to 16.

Aspect 18 is an apparatus for display processing including means for implementing any of aspects 1 to 16.

Aspect 19 is a computer-readable medium (e.g., a non-transitory computer-readable medium) storing computer executable code, the code when executed by at least one processor causes the at least one processor to implement any of aspects 1 to 16.

What is claimed is:

1. An apparatus for graphics processing, comprising:
a memory; and
at least one processor coupled to the memory and, based at least in part on information stored in the memory, the at least one processor is configured to:
obtain a first frame and a second frame of a plurality of frames in a scene, wherein the second frame is subsequent to the first frame in the plurality of frames;
calculate a set of first motion vectors in the first frame and a set of second motion vectors in the second frame, wherein the set of first motion vectors and the set of second motion vectors are calculated based on a block matching procedure for a set of first blocks in the first frame and a set of second blocks in the second frame, wherein each of the set of first blocks includes a plurality of first pixels and each of the set of second blocks includes a plurality of second pixels, wherein the block matching procedure is associated with comparing at least one first block of the set of first blocks to at least one second block of the set of second blocks; and
estimate at least one third frame in the plurality of frames based on the set of first motion vectors in the first frame and the set of second motion vectors in the second frame, wherein the at least one third frame is subsequent to the second frame in the plurality of frames.

2. The apparatus of claim 1, wherein the block matching procedure is associated with a comparison of first depth coordinate for at least one first pixel of a set of first pixels in the at least one first block to a second depth coordinate for at least one corresponding second pixel of a set of second pixels in the at least one second block.

3. The apparatus of claim 1, wherein the at least one processor is further configured to:
perform the block matching procedure for the set of first blocks in the first frame and the set of second blocks in the second frame, wherein the set of first motion vectors and the set of second motion vectors are calculated based on the block matching procedure.

4. The apparatus of claim 3, wherein to perform the block matching procedure, the at least one processor is configured to: compare the at least one first block of the set of first blocks to the at least one second block of the set of second blocks.

5. The apparatus of claim 4, wherein to compare the at least one first block of the set of first blocks to the at least one second block of the set of second blocks, the at least one processor is configured to: compare a first depth coordinate for at least one first pixel of a set of first pixels in the at least one first block to a second depth coordinate for at least one corresponding second pixel of a set of second pixels in the at least one second block.

6. The apparatus of claim 5, wherein to compare the first depth coordinate for the at least one first pixel of the set of first pixels to the second depth coordinate for the at least one corresponding second pixel of the set of second pixels, the at least one processor is configured to: determine whether a difference in the first depth coordinate for each pixel of the set of first pixels and the second depth coordinate for the at least one corresponding second pixel of the set of second pixels is greater than a depth threshold.

7. The apparatus of claim 5, wherein to compare the first depth coordinate for the at least one first pixel of the set of first pixels to the second depth coordinate for the at least one corresponding second pixel of the set of second pixels, the at least one processor is configured to: perform a Z-test for the set of first pixels and the set of second pixels.

8. The apparatus of claim 5, wherein if a difference in the first depth coordinate for the at least one first pixel and the second depth coordinate for the at least one corresponding second pixel is greater than a depth threshold, the at least one processor is configured to:
refrain from comparing the at least one first block to the at least one second block; and
compare the at least one first block of the set of first blocks to at least one third block of a set of third blocks.

9. The apparatus of claim 8, wherein the depth threshold is based on a clustering analysis on at least one frame associated with a depth buffer, or wherein the depth threshold is based on a run-time frame depth buffer analysis associated with the depth buffer.

10. The apparatus of claim 4, wherein to compare the at least one first block of the set of first blocks to the at least one second block of the set of second blocks, the at least one processor is configured to: identify a selected first block in the set of first blocks that is most similar to a selected second block in the set of second blocks.

11. The apparatus of claim 1, wherein the set of first motion vectors is calculated based on at least one of a first color buffer or a first depth buffer associated with the first frame, and wherein the set of second motion vectors is calculated based on at least one of a second color buffer or a second depth buffer associated with the second frame.

12. The apparatus of claim 11, wherein the first depth buffer is a first Z-buffer and the second depth buffer is a second Z-buffer, wherein the first Z-buffer and the second Z-buffer are in at least one of: a graphics processing unit (GPU) hardware cache, a double data rate (DDR) memory, or a system memory.

13. The apparatus of claim 12, wherein the first Z-buffer is a first full resolution buffer or a first low resolution buffer, and wherein the second Z-buffer is a second full resolution buffer or a second low resolution buffer.

14. The apparatus of claim 1, wherein the at least one processor is further configured to:
transmit the at least one third frame after estimating the at least one third frame, wherein the at least one third frame is transmitted to a display or a display panel.

15. The apparatus of claim 1, further comprising at least one of an antenna or a transceiver coupled to the at least one processor, wherein the scene is associated with the graphics processing, computer vision processing, or artificial intelligence (AI) processing, and wherein the block matching procedure is a block searching procedure for the graphics processing, the computer vision processing, or the AI processing.

16. A method of graphics processing, comprising:
obtaining a first frame and a second frame of a plurality of frames in a scene, wherein the second frame is subsequent to the first frame in the plurality of frames;
calculating a set of first motion vectors in the first frame and a set of second motion vectors in the second frame, wherein the set of first motion vectors and the set of second motion vectors are calculated based on a block matching procedure for a set of first blocks in the first frame and a set of second blocks in the second frame, wherein each of the set of first blocks includes a plurality of first pixels and each of the set of second blocks includes a plurality of second pixels, wherein the block matching procedure is associated with comparing at least one first block of the set of first blocks to at least one second block of the set of second blocks; and
estimating at least one third frame in the plurality of frames based on the set of first motion vectors in the first frame and the set of second motion vectors in the second frame, wherein the at least one third frame is subsequent to the second frame in the plurality of frames.

17. The method of claim 16, wherein the block matching procedure is associated with a comparison of first depth coordinate for at least one first pixel of a set of first pixels in the at least one first block to a second depth coordinate for at least one corresponding second pixel of a set of second pixels in the at least one second block.

18. The method of claim 16, further comprising:
performing the block matching procedure for the set of first blocks in the first frame and the set of second blocks in the second frame, wherein the set of first motion vectors and the set of second motion vectors are calculated based on the block matching procedure.

19. The method of claim 18, wherein performing the block matching procedure comprises: comparing the at least one first block of the set of first blocks to the at least one second block of the set of second blocks.

20. The method of claim 19, wherein comparing the at least one first block of the set of first blocks to the at least one second block of the set of second blocks comprises: comparing a first depth coordinate for at least one first pixel of a set of first pixels in the at least one first block to a second depth coordinate for at least one corresponding second pixel of a set of second pixels in the at least one second block.

21. The method of claim 20, wherein comparing the first depth coordinate for the at least one first pixel of the set of first pixels to the second depth coordinate for the at least one corresponding second pixel of the set of second pixels comprises: determining whether a difference in the first depth coordinate for each pixel of the set of first pixels and the second depth coordinate for the at least one corresponding second pixel of the set of second pixels is greater than a depth threshold.

22. The method of claim 20, wherein comparing the first depth coordinate for the at least one first pixel of the set of first pixels to the second depth coordinate for the at least one corresponding second pixel of the set of second pixels comprises: performing a Z-test for the set of first pixels and the set of second pixels.

23. The method of claim 20, wherein if a difference in the first depth coordinate for the at least one first pixel and the second depth coordinate for the at least one corresponding second pixel is greater than a depth threshold, further comprising:
refraining from comparing the at least one first block to the at least one second block; and
comparing the at least one first block of the set of first blocks to at least one third block of a set of third blocks.

24. The method of claim 23, wherein the depth threshold is based on a clustering analysis on at least one frame associated with a depth buffer, or wherein the depth threshold is based on a run-time frame depth buffer analysis associated with the depth buffer.

25. The method of claim 19, wherein comparing the at least one first block of the set of first blocks to the at least one second block of the set of second blocks comprises: identifying a selected first block in the set of first blocks that is most similar to a selected second block in the set of second blocks.

26. The method of claim 16, wherein the set of first motion vectors is calculated based on at least one of a first color buffer or a first depth buffer associated with the first frame, and wherein the set of second motion vectors is calculated based on at least one of a second color buffer or a second depth buffer associated with the second frame, wherein the first depth buffer is a first Z-buffer and the second depth buffer is a second Z-buffer, wherein the first Z-buffer and the second Z-buffer are in at least one of: a graphics processing unit (GPU) hardware cache, a double data rate (DDR) memory, or a system memory, wherein the first Z-buffer is a first full resolution buffer or a first low resolution buffer, and wherein the second Z-buffer is a second full resolution buffer or a second low resolution buffer.

27. The method of claim 16, further comprising:
transmitting the at least one third frame after estimating the at least one third frame, wherein the at least one third frame is transmitted to a display or a display panel.

28. The method of claim 16, wherein the scene is associated with the graphics processing, computer vision processing, or artificial intelligence (AI) processing, and wherein the block matching procedure is a block searching procedure for the graphics processing, the computer vision processing, or the AI processing.

29. An apparatus for graphics processing, comprising:
means for obtaining a first frame and a second frame of a plurality of frames in a scene, wherein the second frame is subsequent to the first frame in the plurality of frames;
means for calculating a set of first motion vectors in the first frame and a set of second motion vectors in the second frame, wherein the set of first motion vectors and the set of second motion vectors are calculated based on a block matching procedure for a set of first blocks in the first frame and a set of second blocks in the second frame, wherein each of the set of first blocks includes a plurality of first pixels and each of the set of second blocks includes a plurality of second pixels, wherein the block matching procedure is associated with comparing at least one first block of the set of first blocks to at least one second block of the set of second blocks; and
means for estimating at least one third frame in the plurality of frames based on the set of first motion vectors in the first frame and the set of second motion vectors in the second frame, wherein the at least one third frame is subsequent to the second frame in the plurality of frames.

30. A computer-readable medium storing computer executable code for graphics processing, the code when executed by a processor causes the processor to:
obtain a first frame and a second frame of a plurality of frames in a scene, wherein the second frame is subsequent to the first frame in the plurality of frames;
calculate a set of first motion vectors in the first frame and a set of second motion vectors in the second frame, wherein the set of first motion vectors and the set of second motion vectors are calculated based on a block matching procedure for a set of first blocks in the first frame and a set of second blocks in the second frame, wherein each of the set of first blocks includes a plurality of first pixels and each of the set of second blocks includes a plurality of second pixels, wherein the block matching procedure is associated with comparing at least one first block of the set of first blocks to at least one second block of the set of second blocks; and
estimate at least one third frame in the plurality of frames based on the set of first motion vectors in the first frame and the set of second motion vectors in the second frame, wherein the at least one third frame is subsequent to the second frame in the plurality of frames.
